(19) United States
(12) Patent Application Publication
(10) Pub. No.: US 2026/0229180 A1
(43) Pub. Date: Aug. 6, 2026

(54) FREQUENCY VARIABLE DISPLAY APPARATUS

(71) Applicant: LG Display Co., Ltd., Seoul (KR)

(72) Inventors: Seok Min CHOI, Paju-si (KR); Moo Kyoung HONG, Paju-si (KR)

(73) Assignee: LG Display Co., Ltd., Seoul (KR)

(21) Appl. No.: 19/447,801

(22) Filed: Jan. 13, 2026

(30) Foreign Application Priority Data
Jan. 24, 2025 (KR) 10-2025-0011813

(51) Int. Cl. G09G 3/3233

(52) U.S. Cl. CPC G09G 3/3233; G09G 2300/0814; G09G 2310/0245; G09G 2310/061; G09G 2320/0247

(57) ABSTRACT

A frequency variable display apparatus is provided. In the frequency variable display apparatus, one frame period comprises a vertical active period during which a data voltage is input to a subpixel and a vertical blank period which follows the vertical active period and during which the data voltage is not input to the subpixel. Also, in the one frame period with a frame frequency lower than a predetermined maximum frame frequency in a variable frame frequency range, a scan signal applied to the subpixel has one gate on period to turn on a first switch transistor connected between a data line and a driving transistor, and the sense signal applied to the subpixel has two or more gate on periods to turn on a second switch transistor connected between the driving transistor and a reference voltage line.

### CROSS-REFERENCE TO RELATED APPLICATION

This application claims the benefit of Korean Patent Application No. 10-2025-0011813, filed on January 24, 2025, which is hereby incorporated by reference as if fully set forth herein.

### BACKGROUND

### Field of the Disclosure

The present disclosure relates to a frequency variable display apparatus.

### Discussion of the Related Art

Frequency variable display apparatuses vary a frame frequency of an image displayed on a screen, based on an attribute of video data received from an external video source. Frequency variable display apparatuses support a variable refresh rate (VRR) function which varies a frame frequency within a predetermined frequency range.

When a frame frequency is rapidly changed from a low-speed frame to a high-speed frame, or vice versa, by a VRR operation, a flicker phenomenon caused by a recognition luminance deviation may be recognized by a user. To decrease the recognition luminance deviation, luminance algorithm technology which adjusts a data gain according to a frame frequency has been known. However, in such technology, because a data gain of a current frame is determined based on frequency information about a previous frame, there is a limitation in decreasing a recognition luminance deviation (i.e., VRR flicker) between a first frame immediately after a frame frequency is rapidly changed and a frame immediately before the first frame.

### SUMMARY

Accordingly, the present disclosure is directed to a frequency variable display apparatus that substantially obviates one or more problems due to limitations and disadvantages of the related art.

To overcome the aforementioned limitations of the related art, the present disclosure provides a frequency variable display apparatus which may decrease VRR flicker occurring when a frame frequency is rapidly changed.

Additional advantages, aspects, and features of the present disclosure will be set forth in part in the description which follows and in part will become apparent to those having ordinary skill in the art upon examination of the following description or may be learned from practice of the present disclosure. The aspects and other advantages of the present disclosure may be realized and attained by the structure particularly pointed out in the written description and claims hereof as well as the appended drawings.

To achieve these objects and other advantages and in accordance with the purpose of the disclosure, as embodied and broadly described herein, a frequency variable display apparatus includes: a display panel including a plurality of subpixels, each including a driving transistor including a gate electrode connected to a first node, a drain electrode connected to a high-level source voltage, and a source electrode connected to a second node, a first switch transistor configured to connect the first node to a data line based on a scan signal, the data line being configured to receive a data voltage, a second switch transistor configured to connect the second node to a reference voltage line based on a sense signal, the reference voltage line being configured to receive an initialization voltage, a storage capacitor connected between the first node and the second node, and a light emitting element including an anode electrode connected to the second node and a cathode electrode connected to a low-level source voltage; and a gate driver configured to supply the scan signal to a scan gate line connected to a gate electrode of the first switch transistor and to supply the sense signal to a sense gate line connected to a gate electrode of the second switch transistor, wherein one frame period includes a vertical active period during which the data voltage is input to a corresponding one of the subpixels and a vertical blank period which follows the vertical active period and during which the data voltage is not input to the corresponding one of the subpixels, and wherein, in the one frame period with the display panel driven at a frame frequency lower than a predetermined maximum frame frequency within a variable frame frequency range, the sense signal has one or more gate on periods to turn on the second switch transistor during the vertical blank period.

In another aspect of the present disclosure, a frequency variable display apparatus includes: a display panel including a plurality of subpixels, each including a driving transistor including a gate electrode connected to a first node, a drain electrode connected to a high-level source voltage, and a source electrode connected to a second node, a first switch transistor configured to connect the first node to a data line based on a scan signal, the data line being configured to receive a data voltage, a second switch transistor configured to connect the second node to a reference voltage line based on a sense signal, the reference voltage line being configured to receive an initialization voltage, a storage capacitor connected between the first node and the second node, and a light emitting element including an anode electrode connected to the second node and a cathode electrode connected to a low-level source voltage; and a gate driver configured to supply the scan signal to a scan gate line connected to a gate electrode of the first switch transistor and to supply the sense signal to a sense gate line connected to a gate electrode of the second switch transistor, wherein, in one frame period with the display panel driven at a frame frequency lower than a predetermined maximum frame frequency within a variable frame frequency range, the scan signal supplied to one of the subpixels has one gate on period, and the sense signal supplied to the one of the subpixels has two or more gate on periods.

In yet another aspect of the present disclosure, a display apparatus includes: a display panel configured to be driven at a variable frame frequency within a frequency range, the display panel comprising a subpixel including a driving transistor having a gate electrode connected to a first node and a first electrode connected to a second node, a first switch transistor having a gate electrode connected to a scan gate line, a first electrode connected to a data line configured to receive a data voltage, and a second electrode connected to the first node, a second switch transistor having a gate electrode connected to a sense gate line, a first electrode connected to a reference voltage line configured to receive an initialization voltage, and a second electrode connected to the second node, and a light emitting element connected to the second node; a data driver configured to provide the data voltage to the data line; and a gate driver configured to provide a scan signal to the scan gate line and to provide a sense signal to the sense gate line. During an n^{th} frame (n being a natural number) with the display panel driven at a frame frequency lower than a predetermined maximum frame frequency within the frequency range, the scan signal may have one gate on period, and the sense signal may have two or more gate on periods.

It is to be understood that both the foregoing general description and the following detailed description of the present disclosure are by way of example and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate example embodiment(s) of the present disclosure and together with the description serve to explain various principles of the disclosure. In the drawings:

FIG. 1 is a block diagram illustrating a frequency variable display apparatus according to an example embodiment of the present disclosure;

FIG. 2 is a diagram illustrating a connection configuration of one pixel according to an example embodiment of the present disclosure;

FIG. 3 is a diagram illustrating a vertical active period and a vertical blank period configuring one example frame period;

FIG. 4 is a diagram illustrating an example where a length of a vertical front porch included in a vertical blank period varies based on a level of a frame frequency;

FIG. 5 is a diagram illustrating an example where recognition luminance is changed based on a level of a frame frequency;

FIG. 6 is a diagram illustrating VRR flicker occurring in a rapid change condition of a frame frequency;

FIGS. 7 and 8 are diagrams illustrating an example where the visibility of VRR flicker is higher at a low gray level than at a high gray level;

FIG. 9A is a diagram illustrating a conventional VRR driving method where a programming operation is performed in only a vertical active period;

FIG. 9B is a diagram illustrating a VRR driving method where a programming operation is performed in a vertical active period and a copy programming operation is performed in a vertical blank period, according to an example embodiment of the present disclosure;

FIG. 10 is a diagram illustrating an example configuration which supplies a scan signal and a sense signal in a VRR driving method according to an example embodiment differentiated from a conventional VRR driving method;

FIG. 11 is a diagram illustrating a gate-source voltage difference of a subpixel based on a VRR driving method according to an example embodiment in a vertical active period and a vertical blank period included in one frame period;

FIG. 12A is a diagram illustrating an operation of a subpixel in a programming period of the vertical active period of FIG. 11;

FIG. 12B is a diagram illustrating an operation of a subpixel in an emission period of the vertical active period of FIG. 11;

FIG. 12C is a diagram illustrating an operation of a subpixel in a copy programming period of the vertical blank period of FIG. 11;

FIG. 12D is a diagram illustrating an operation of a subpixel in an emission period of the vertical blank period of FIG. 11;

FIG. 13 is a diagram illustrating an example where luminance flashing occurs in a conventional VRR driving method;

FIG. 14 is a diagram illustrating an example where luminance flashing is prevented in a VRR driving method according to an example embodiment of the present disclosure; and

FIG. 15 is a diagram illustrating a feature associated with an interval between a plurality of gate on periods included in a sense signal in a VRR driving method according to an example embodiment of the present disclosure.

### DETAILED DESCRIPTION

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure will be more thorough and complete, and will more fully convey the scope of the present disclosure to those skilled in the art. Furthermore, a protected scope of the present disclosure may be defined by the claims and their equivalents.

The shapes, sizes, ratios, angles, numbers, and the like disclosed in the drawings for description of various example embodiments of the present disclosure are merely by way of example, and the present disclosure is not limited thereto. Like reference numerals refer to like elements throughout. Throughout this specification, the same elements are denoted by the same reference numerals unless otherwise specified.

As used herein, such terms as “comprise,” “having,” “including,” and the like suggest that other parts can be added unless a more specific term like “only” is used. As used herein, the singular forms “a,” “an,” and “the” are intended to include the plural forms as well, unless the context clearly indicates otherwise.

Elements in various embodiments of the present disclosure are to be interpreted as including margins of error even without explicit statements.

In the description of a positional relationship, for example, where a positional relation between two parts is described as “on,” “over,” “under,” “next,” and the like, one or more other parts may be disposed between the two parts unless a more specific term like “just” or “directly” is used.

It should be understood that, although the terms like “first,” “second,” and so on may be used herein to describe various elements, these elements should not be interpreted as limited by these terms. These terms are used only to refer to one element separately from another. For example, a first element could be termed a second element, and, similarly, a second element could be termed a first element, without departing from the scope of the present disclosure.

In the following description, where the detailed description of the relevant known function or configuration may unnecessarily obscure a feature or aspect of the present disclosure, the detailed description of such known function or configuration may be omitted.

Hereinafter, example embodiments of the present disclosure will be described in detail with reference to the accompanying drawings.

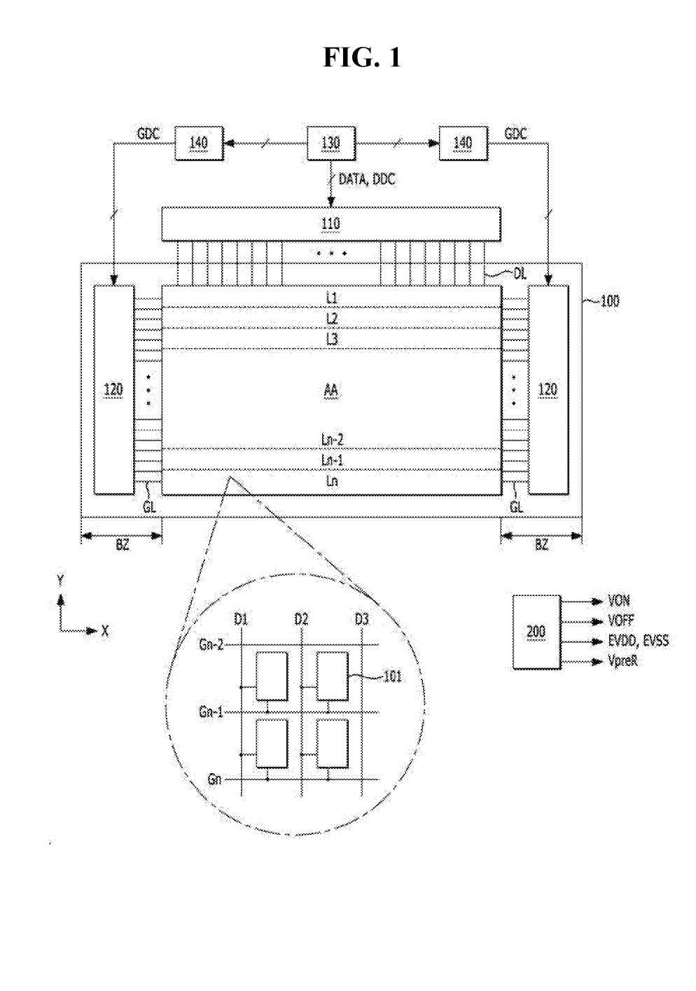

FIG. 1 is a block diagram illustrating a frequency variable display apparatus according to an example embodiment of the present disclosure.

As illustrated in FIG. 1, a display panel 100 may include a screen (or an active area) AA which displays an input image. The screen AA may include a pixel array which displays pixel data (hereinafter referred to as “image data”) DATA of an input image. The pixel array may include a plurality of data lines DL, a plurality of gate lines GL intersecting with the data lines DL, a plurality of reference voltage lines, and a plurality of pixels.

The pixels may be arranged on the screen AA in a matrix type defined by the data lines DL, the gate lines GL, and the reference voltage lines. The pixels may be arranged as various types, such as a stripe type and a diamond type as well as a matrix type, on the screen AA.

The pixel array may include a plurality of pixel columns and a plurality of pixel lines L1 to Ln intersecting with the pixel columns. Each of the pixel columns may include pixels which are arranged in a Y-axis direction. A pixel line may include pixels which are arranged in an X-axis direction. One vertical period may be one frame period for writing image data DATA of one frame to all pixels of the screen AA. One horizontal period may be a time obtained by dividing one frame period by the number of pixel lines L1 to Ln. One horizontal period may be a time period for writing the image data DATA of one pixel row, sharing a gate line GL, to pixels of one pixel row, e.g., one of L1 to Ln.

Each of the pixels may include a red (R) subpixel 101, a green (G) subpixel 101, a blue (B) subpixel 101, and a white (W) subpixel 101 for implementing colors.

The frequency variable display apparatus according to an example embodiment of the present disclosure may be implemented as an organic light emitting display apparatus. In this case, a pixel circuit of the frequency variable display apparatus may include a light emitting element, a driving element, one or more switch elements, and a capacitor. The light emitting element may be implemented as an organic light emitting diode (OLED). A driving current which allows the light emitting element to emit light may be adjusted based on a gate-source voltage of the driving element. Each of the driving element and the switch element(s) may be implemented as a transistor. A semiconductor layer of the transistor may include amorphous silicon or polysilicon. Semiconductor layers of at least some of transistors may include oxide. The pixel circuit may be connected to a data line DL and a gate line GL. In FIG. 1, “D1 to D3” illustrated in a circle may be data lines, and “Gn-2 to Gn” may be gate lines.

Touch sensors may be disposed on the display panel 100. The touch sensors may be arranged as an on-cell or add-on type on the screen AA of the display panel 100, or may be implemented as in-cell type touch sensors embedded in the pixel array. A touch input may be sensed through the touch sensors or may be sensed through only pixels even without touch sensors.

A source driver 110 may convert the image data DATA, received from a timing controller 130, into gamma compensation voltages by using a digital-to-analog converter (DAC) to generate data voltages. The source driver 110 may supply the data voltages to the data lines DL. The data voltages may be applied to gate electrodes of the driving elements through the switch element(s) of the subpixels 101. The source driver 110 may supply an initialization voltage VpreR, received from a power circuit 200, to reference voltage lines connected to the subpixels. The initialization voltage VpreR may be supplied to the reference voltage lines and may be applied to a source electrode of the driving element through a switch element of each subpixel 101.

The source driver 110 may be implemented with one or more source drive integrated circuits (ICs). The source drive IC(s) may be connected to the timing controller 130 through an internal interface circuit. The internal interface circuit may be implemented as an embedded clock point to point interface (EPI). The source drive IC(s) may further include a touch driver. The touch driver may generate a touch sensor driving signal and may convert an electric charge variation of a touch sensor into touch raw data. The touch driver may transfer the touch raw data to a host system (not shown) through a separate interface circuit. The separate interface circuit may be implemented as a serial peripheral interface (SPI).

A gate driver 120 may be provided in a bezel area BZ disposed outside the screen AA in the display panel 100. The bezel area BZ may be an area not configured to display an image. The gate driver 120 may sequentially supply a gate signal, synchronized with data voltages, to the gate lines GL according to a control by the timing controller 130. The gate signal may simultaneously activate pixels of the same pixel row into which a data voltage is charged. The gate driver 120 may output the gate signal by using one or more shift registers and may shift the gate signal. The gate signal may be referred to as a scan signal. The scan signal may include a gate on voltage VON and a gate off voltage VOFF, which are received from the power circuit 200.

The timing controller 130 may receive video data DATA and a timing signal, synchronized with the video data DATA, from the host system (not shown). The timing signal may include a vertical synchronization signal Vsync, a horizontal synchronization signal Hsync, a clock signal DCLK, and a data enable signal DE. The vertical synchronization signal Vsync may define a vertical period (i.e., one frame). The horizontal synchronization signal Hsync may define a horizontal period. The data enable signal DE may define a time (i.e., a vertical active period) where data voltages are input to subpixels in a vertical period. The other time, except the vertical active period, of the vertical period may be a vertical blank period. The data enable signal DE may swing in the vertical active period and may not swing in the vertical blank period.

The timing controller 130 may generate a source timing control signal DDC for controlling an operation timing of the source driver 110 and a gate timing control signal GDC for controlling an operation timing of the gate driver 120, based on the timing signal Vsync, Hsync, and DE received from the host system.

The host system may be one of a television (TV), a set-top box, a navigation system, a personal computer (PC), a home theater, an automotive display system, a mobile device, and a wearable device, but is not limited thereto. In the mobile device and the wearable device, the source driver 110, the timing controller 130, and a level shifter 140 may be integrated into one drive IC.

The level shifter 140 may shift a logic voltage level of the gate timing control signal GDC, output from the timing controller 130, to the gate on voltage VON or the gate off voltage VOFF to supply to the gate driver 120. A low logic voltage of the gate timing control signal GDC may be down-shifted to the gate off voltage VOFF, and a high logic voltage of the gate timing control signal GDC may be up-shifted to the gate on voltage VON.

The power circuit 200 may generate various source voltages used for panel driving. The power circuit 200 may generate the gate on voltage VON and the gate off voltage VOFF used for generating of the scan signal, generate a high-level source voltage EVDD and a low-level source voltage EVSS which are to be supplied to each subpixel 101, and generate the initialization voltage VpreR which is to be supplied to a reference voltage line.

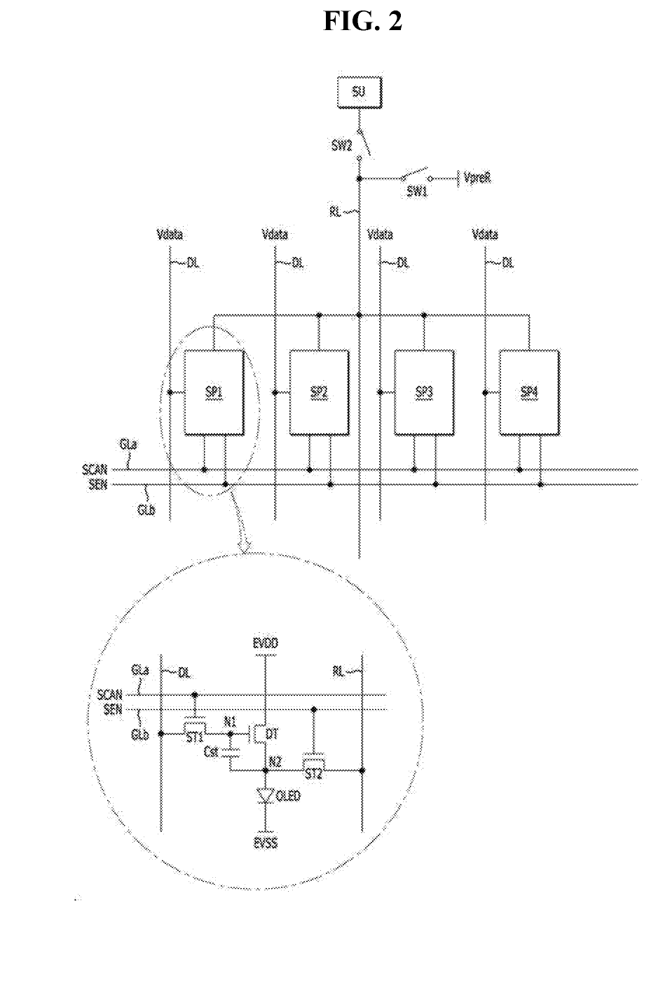

FIG. 2 is a diagram illustrating a connection configuration of an example pixel PXL according to an example embodiment of the present disclosure.

As shown in FIG. 2, the example pixel PXL may include four subpixels SP1 to SP4 which share a reference voltage line RL. The four subpixels SP1 to SP4 may be R, G, B, and W subpixels for configuring the same pixel. Each of the subpixels SP1 to SP4 may include, for example, a light emitting element OLED, a driving transistor DT, first and second switch transistors ST1 and ST2, and a storage capacitor Cst.

The light emitting element OLED may emit light with a driving current supplied from the driving transistor DT to implement luminance. An anode electrode of the light emitting element OLED may be connected to a second node N2, and a cathode electrode thereof may be connected to an input terminal of a low-level source voltage EVSS.

The driving transistor DT may be a driving element which generates the driving current based on a gate-source voltage difference thereof to supply the driving current to the light emitting element OLED. A gate electrode of the driving transistor DT may be connected to a first node N1, a drain electrode thereof may be connected to an input terminal of a high-level source voltage EVDD, and a source electrode thereof may be connected to the second node N2.

A gate electrode of the first switch transistor ST1 may be connected to a scan gate line GLa, a first electrode thereof may be connected to a data line DL, and a second electrode thereof may be connected to the first node N1. The first switch transistor ST1 may connect the first node N1 to the data line DL to which a data voltage Vdata is supplied, based on a scan signal SCAN from the scan gate line GLa.

A gate electrode of the second switch transistor ST2 may be connected to a sense gate line GLb. A first electrode of the second switch transistor ST2 may be connected to the reference voltage line RL, and a second electrode thereof may be connected to the second node N2. The second switch transistor ST2 may connect the second node N2 to the reference voltage line RL to which an initialization voltage VpreR is supplied, based on a sense signal SEN from the sense gate line GLb.

One electrode of the storage capacitor Cst may be connected to the first node N1, and the other electrode thereof may be connected to the second node N2.

A first switch SW1 and a second switch SW2 may be further connected to the reference voltage line RL. The first switch SW1 may connect an input terminal of the initialization voltage VpreR to the reference voltage line RL. The second switch SW2 may connect the reference voltage line RL to a sensing circuit SU for sensing an electrical characteristic (threshold voltage or electron mobility) of the driving transistor DT.

In an n^{th} (where n may be a natural number) frame, the first switch SW1 may be turned on so that a gate-source voltage difference of the driving transistor DT is programmed. While the second switch SW2 is being turned on, an electrical connection between the input terminal of the initialization voltage VpreR and the reference voltage line RL may be disconnected. While the second switch SW2 is being turned on, a sampling operation of the sensing circuit SU may be performed.

The first switch SW1 and the second switch SW2 may be included in the source driver 110. However, in an example configuration employing no sensing function, the second switch SW2 and the sensing circuit SU may be omitted.

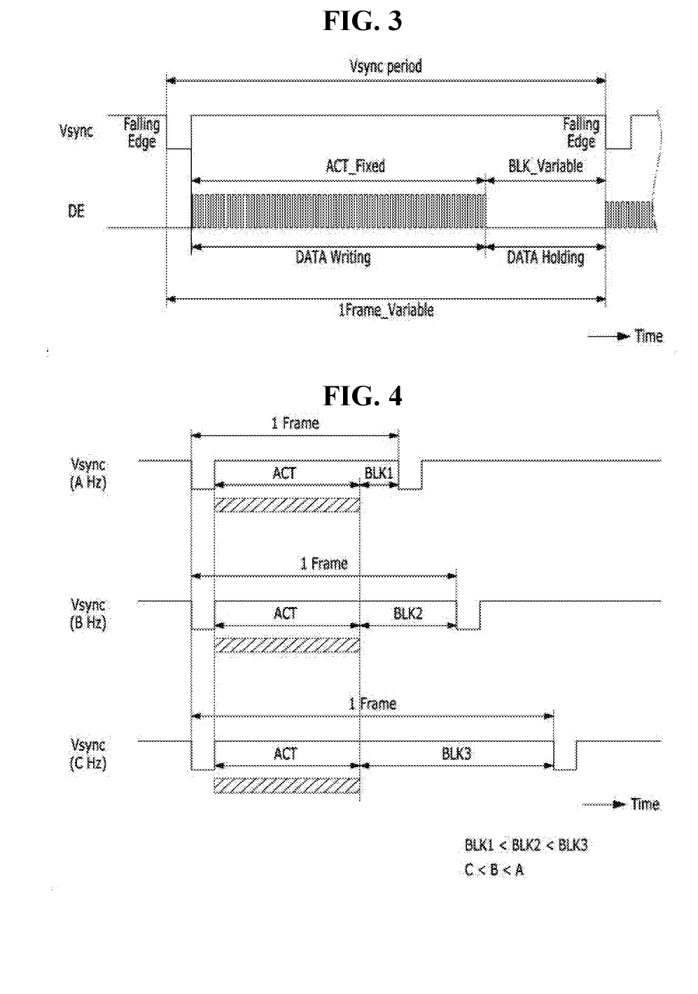

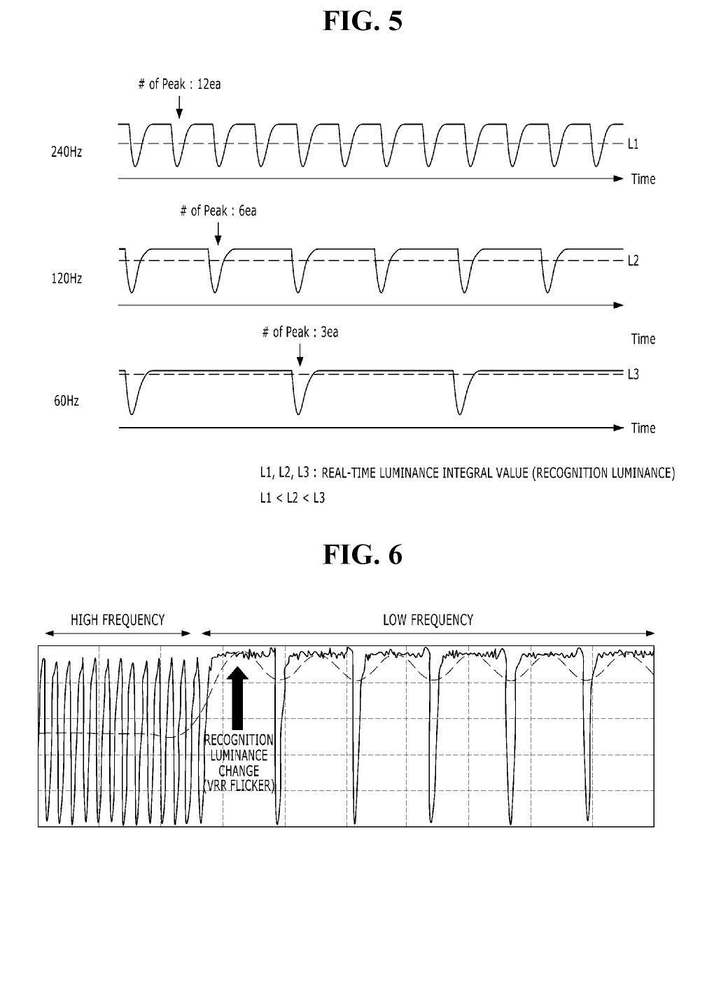

FIG. 3 is a diagram illustrating a vertical active period and a vertical blank period configuring one example frame period. FIG. 4 is a diagram illustrating an example where a length of a vertical front porch included in a vertical blank period varies based on a level of a frame frequency.

As illustrated in FIG. 3, one frame period (vertical period) may be defined by a vertical synchronization signal Vsync. The one frame period (vertical period) may be defined as a time interval between adjacent falling edges (or rising edges) of the vertical synchronization signal Vsync.

A vertical active period ACT and a vertical blank period BLK in the one frame period (vertical period) may be defined by a data enable signal DE. The vertical active period ACT may be a period where the data enable signal DE swings (e.g., between high and low levels), and the vertical blank period BLK may be a period where the data enable signal DE does not swing.

The frequency variable display apparatus according to example embodiments of the present disclosure may have a VRR mode where a length of one frame varies within a variable frequency range of a predetermined max frame frequency or less. Hereinafter, in example embodiments of the present disclosure, the max frame frequency may be described to be 240 Hz, but the inventive concept or the present disclosure is not limited thereto. In the VRR mode, as in FIG. 4, a frame frequency may be changed to A, B, and C Hz. When a frame frequency is changed, a length of one frame period may vary based thereon. In the VRR mode, a length of the vertical active period ACT may be fixed to a certain value which is defined with respect to the max frame frequency, and a length of the vertical blank period BLK may vary based on a frame frequency. A length of the vertical blank period may be BLK1 based on a frame frequency of A Hz, may be BLK2 based on a frame frequency of B Hz, and may be BLK3 based on a frame frequency of C Hz. Here, when A>B>C, BLK1<BLK2<BLK3.

During the vertical active period ACT of a fixed length, a difference voltage (i.e., a gate-source voltage difference of a driving transistor) between an initialization voltage and a data voltage corresponding to image data DATA in each pixel may be set. Such a setting operation may be referred to as a programming operation. When the programming operation is completed, a source voltage of the driving transistor may increase up to a threshold voltage of a light emitting element while maintaining the gate-source voltage difference of the driving transistor set in the subpixels.

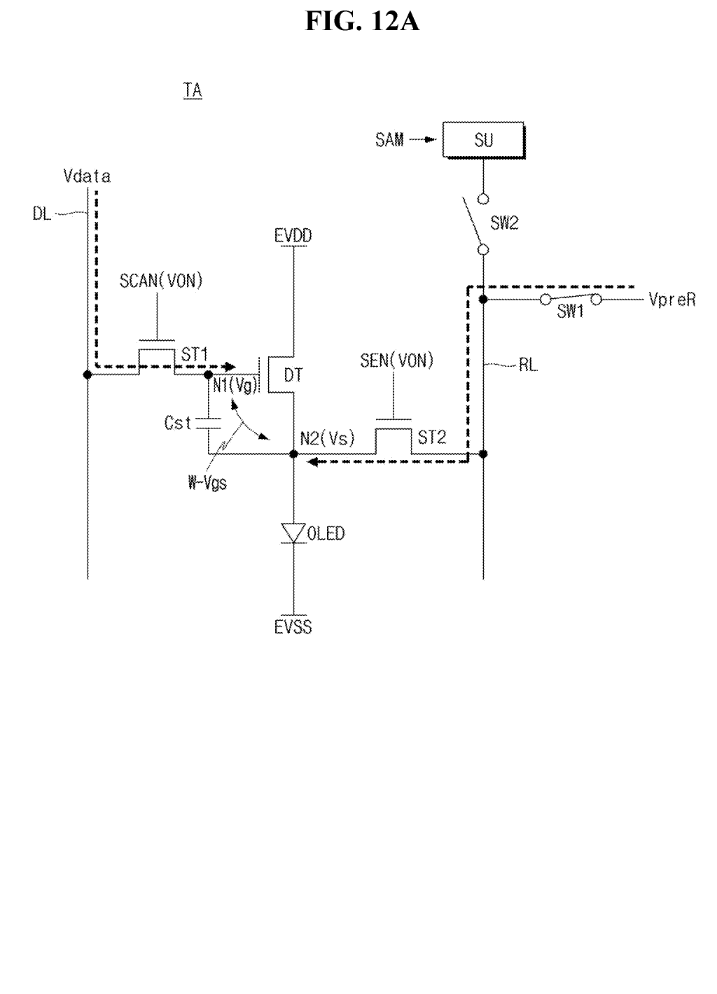

To reduce VRR flicker, a copy programming operation may be further performed during the vertical blank period BLK of a variable length. This will be described below in detail with reference to FIGS. 9B, 10, 11, 12A to 12D, 14, and 15.

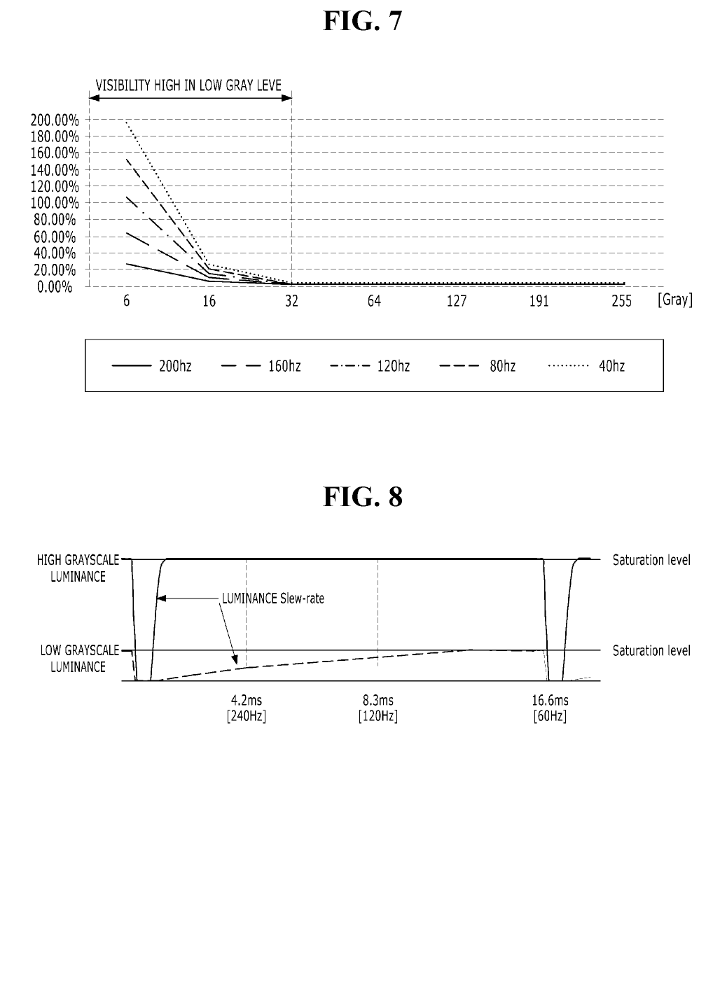

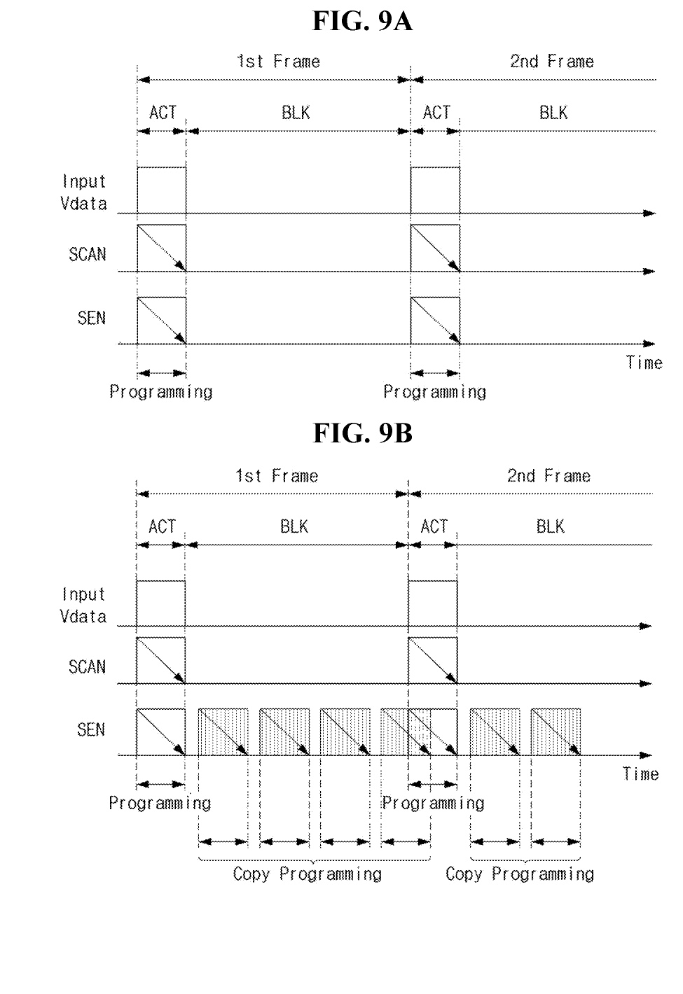

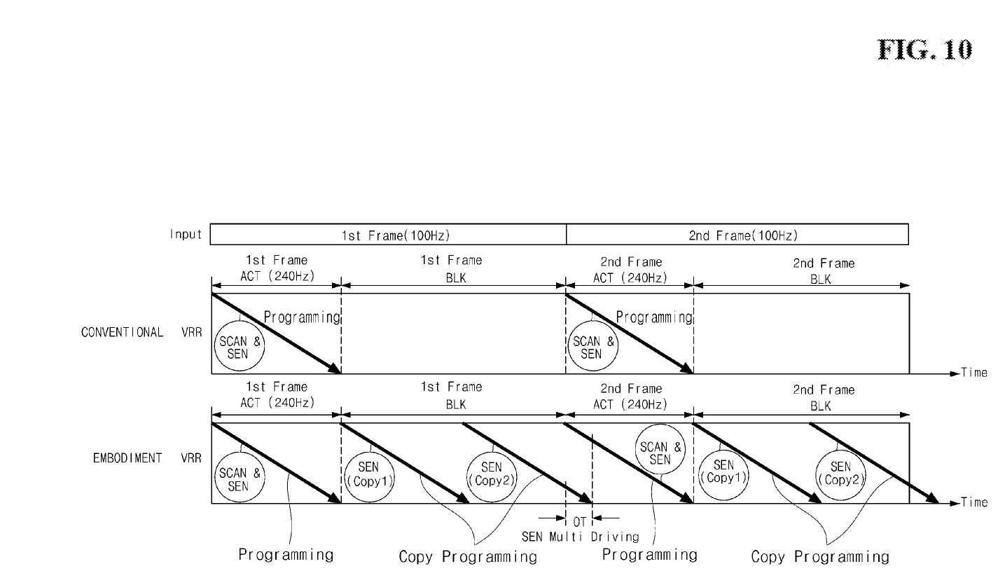

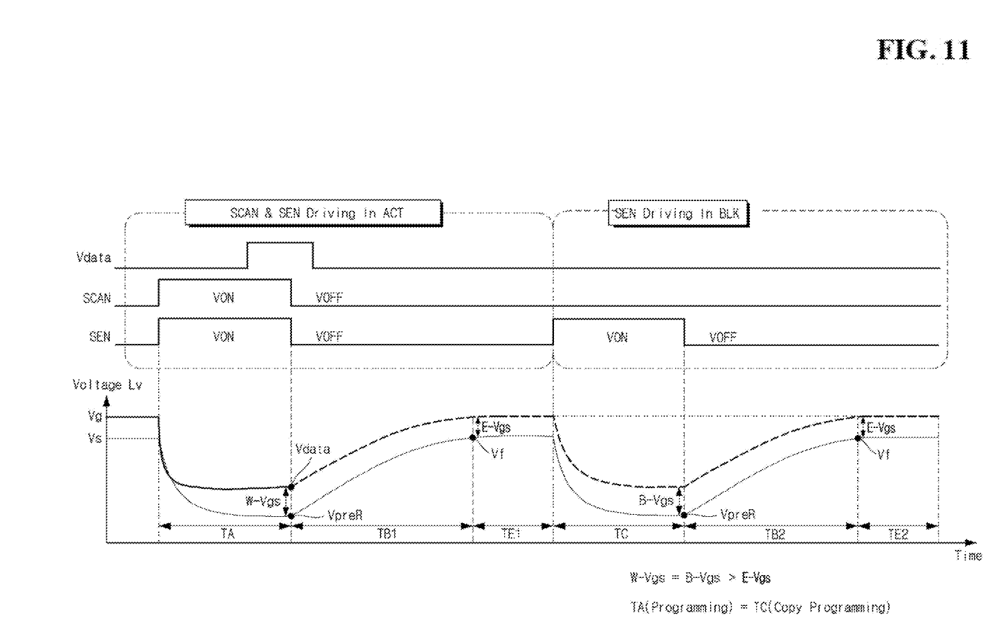

FIG. 5 is a diagram illustrating an example where recognition luminance is changed based on a level of a frame frequency. FIG. 6 is a diagram illustrating VRR flicker occurring in a rapid change condition of a frame frequency. FIGS. 7 and 8 are diagrams illustrating an example where the visibility of VRR flicker is higher at a low gray level than at a high gray level.

Peak low luminance points of FIGS. 5 and 6 may be points at which programming operations are performed. An emission operation of a light emitting element OLED may stop while the programming operation is being performed, and the emission operation of the light emitting element OLED may be performed after the programming operation is performed.

The programming operation and the emission operation may be successively performed in one frame. The number of programming operations may increase as the number of frame arrangements in a predetermined time increases, namely, a frame frequency increases. Thus, recognition luminance may be lowered. For example, the number of programming operations in a predetermined time in a frame frequency of 240 Hz may be twelve, the number of programming operations in a predetermined time in a frame frequency of 120 Hz may be six, and the number of programming operations in a predetermined time in a frame frequency of 60 Hz may be three. As a result, a real-time luminance integral value (i.e., recognition luminance) of a frame frequency of 240 Hz may be L1, a real-time luminance integral value (i.e., recognition luminance) of a frame frequency of 120 Hz may be L2 which is higher than L1, and a real-time luminance integral value (i.e., recognition luminance) of a frame frequency of 60 Hz may be L3 which is higher than L2.

As described above, when a gray level of a display image is assumed to be constant, recognition luminance may be relatively higher when a frame frequency is at a low frequency than when the frame frequency is at a high frequency. Accordingly, VRR flicker caused by a change in recognition luminance may occur when the frame frequency is changed from a high frequency to a low frequency.

A recognized level of VRR flicker, as illustrated in FIGS. 7 and 8, may be relatively higher in a low grayscale period than in a high grayscale period. In a case where an amount of time taken until reaching a target luminance saturation level immediately after programming is defined as a luminance slew rate, a luminance slew rate of a high grayscale image may be relatively higher than a luminance slew rate of a low grayscale image. Accordingly, VRR flicker caused by a change in frequency may not be largely recognized (thus may not be a significant issue) in a high grayscale image, but may be clearly recognized when displaying a low grayscale image.

FIG. 9A is a diagram illustrating a conventional VRR driving method where a programming operation is performed in only a vertical active period. FIG. 9B is a diagram illustrating a VRR driving method where a programming operation is performed in a vertical active period and a copy programming operation is performed in a vertical blank period, according to an example embodiment of the present disclosure.

As shown in FIG. 9A, in a VRR driving method where a programming operation is performed in only a vertical active period ACT, as described with reference to FIG. 5, a real-time luminance integral value (i.e., recognition luminance) may increase as a frame frequency is reduced. Thus, VRR flicker caused by a change in recognition luminance may occur when the frame frequency is rapidly changed from a high frequency to a low frequency.

On the other hand, as shown in FIG. 9B, in a VRR driving method where a programming operation is performed in a vertical active period ACT and a copy programming operation is performed in a vertical blank period BLK, a change in recognition luminance according to a change in a frame frequency may be minimized or reduced, and VRR flicker may be suppressed.

As illustrated in FIG. 9B, the programming operation may be implemented by a sense signal SEN and a scan signal SCAN, which are synchronized with an input of a data voltage Vdata and have a gate on period in the vertical active period ACT.

The copy programming operation may be implemented by one or more sense signals SEN having a gate on period in the vertical blank period BLK where there is no input of the data voltage Vdata. The gate on period may be defined as a period where a gate on voltage capable of turning on first and second switch transistors ST1 and ST2 of a subpixel is maintained. In the vertical blank period BLK, the scan signal SCAN may not have the gate on period and may maintain a gate off voltage. The gate off voltage may be a voltage capable of turning off the first and second switch transistors ST1 and ST2 of the subpixel.

During the vertical blank period BLK, in a state where a gate electrode of a driving transistor DT is floated by the scan signal SCAN of the gate off voltage, an initialization voltage VpreR may be applied to a source electrode of the driving transistor DT by the sense signal SEN of the gate on voltage. Thus, the copy programming operation may be implemented. Based on the initialization voltage VpreR applied to the source electrode of the driving transistor DT, a source voltage of the driving transistor DT may decrease up to the initialization voltage VpreR from a threshold voltage of a light emitting element OLED. At this time, because a gate electrode of the driving transistor DT is coupled to the source electrode through a storage capacitor Cst, a gate voltage of the driving transistor DT may be lowered. A gate-source voltage difference of the driving transistor DT based on the copy programming operation may be substantially the same as a gate-source voltage difference of the driving transistor DT based on the programming operation.

Like a programming period of the vertical blank period ACT, because the source voltage of the driving transistor DT is lower than a threshold voltage of a light emitting element OLED in a copy programming period of the vertical blank period BLK, the light emitting element OLED may not emit light. The number of copy programming periods included in the vertical blank period BLK may increase as the vertical blank period BLK increases in length Thus, a luminance flashing phenomenon occurring in a long vertical blank period BLK of a low-frequency frame may be suppressed or reduced. As a result, VRR flicker occurring when the frame frequency is rapidly changed from a high frequency to a low frequency may be suppressed or reduced.

The copy programming period may not be allocated in a vertical blank BLK period of a shortest frame period corresponding to a max frame frequency within a variable frequency range. The copy programming period may be allocated in a vertical blank period BLK of a frame period under a frame frequency condition which is lower than the max frame frequency.

The vertical blank period BLK may include one or more copy programming periods, and the number of allocated programming periods may be proportional to a length of the vertical blank period BLK. For example, the number of copy programming periods included in a vertical blank period BLK of a second length longer than a first length may be more than the number of copy programming periods included in a vertical blank period BLK of the first length.

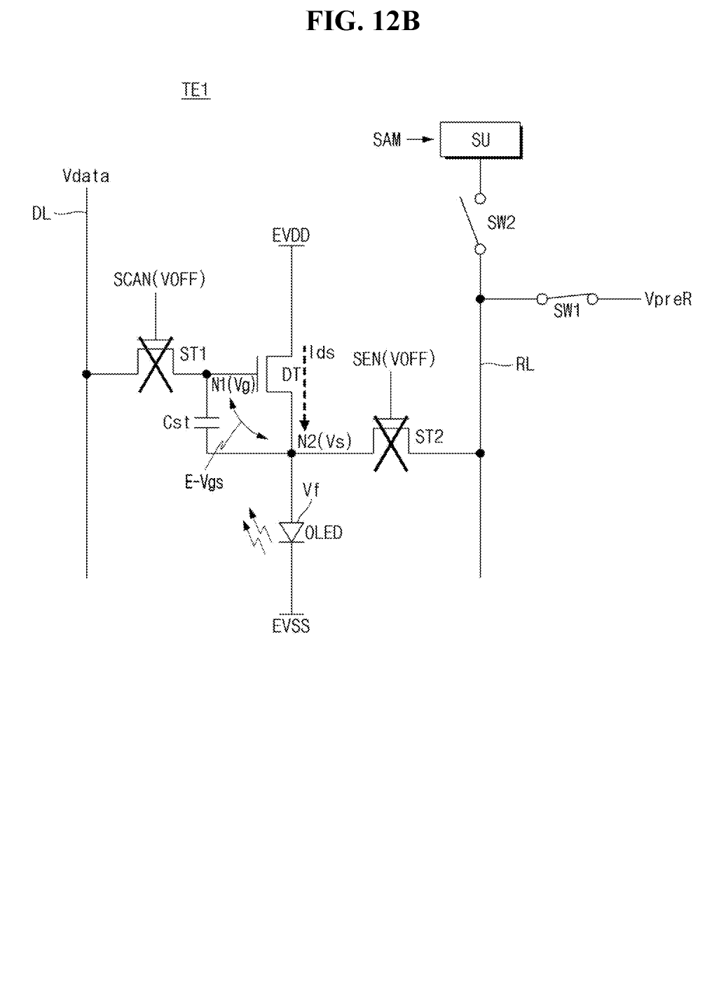

FIG. 10 is a diagram illustrating an example configuration which supplies a scan signal and a sense signal in a VRR driving method according to an example embodiment of the present disclosure differentiated from a conventional VRR driving method.

As illustrated in FIG. 10, in a conventional VRR driving method, a scan signal SCAN and a sense signal SEN may be synchronized with each other and sequentially supplied by units of pixel row, for a programming operation during a vertical active period ACT. In each of a first frame and a second frame of 100 Hz, a length of a vertical active period ACT may be defined with respect to 240 Hz which is the max frame frequency. Also, the scan signal SCAN and the sense signal SEN may be configured not to be supplied to pixel rows in the vertical blank period BLK.

On the other hand, in the VRR driving method according to an example embodiment of the present disclosure, the scan signal SCAN and the sense signal SEN may be synchronized with each other and sequentially supplied by units of pixel row, for a programming operation during the vertical active period ACT, and then, the sense signal SEN may be sequentially supplied by units of pixel row, for a copy programming operation of the vertical blank period BLK.

In each of a first frame and a second frame of 100 Hz, a length of the vertical blank period BLK may be greater than that of the vertical active period ACT. In the vertical blank period BLK of each of the first frame and the second frame, a copy programming operation may be performed twice on each subpixel.

A length of the vertical blank period BLK may be non-integer times greater than that of the vertical active period ACT. In this case, a supply timing of a sense signal SEN for a second copy programming operation of the first frame and a supply timing of a sense signal SEN for a programming operation of the second frame may overlap each other by a certain time OT. As a result, “SEN Multi Driving” may be performed at the certain overlapping time OT. Unlike a programming operation, because a data voltage is not supplied in a copy programming operation, a problem of driving may not occur even when “SEN Multi Driving” is performed.

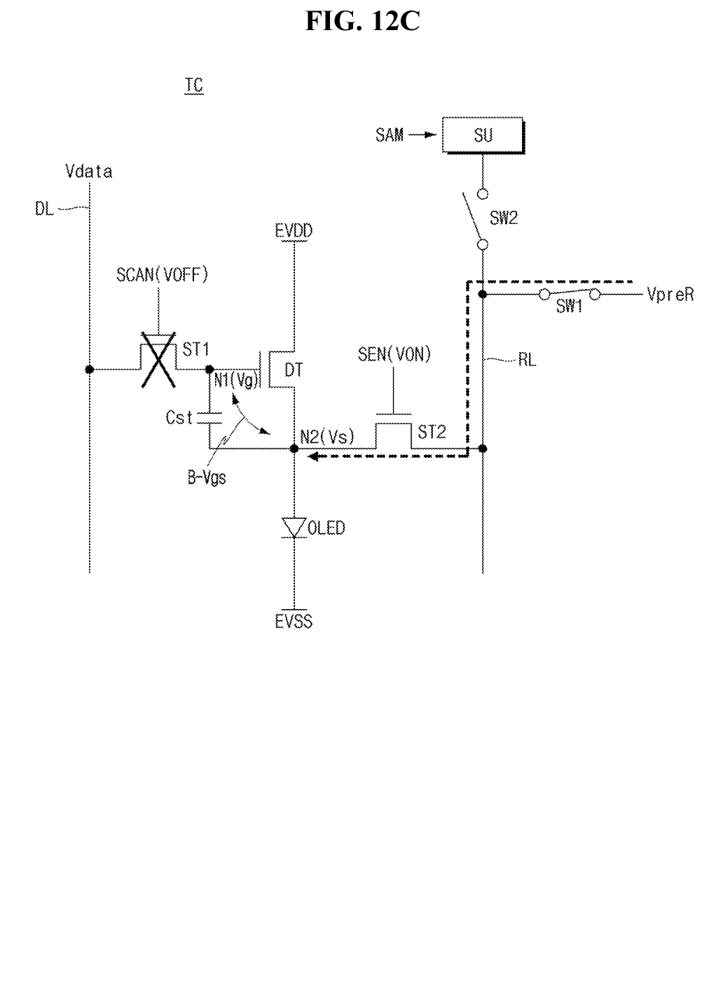

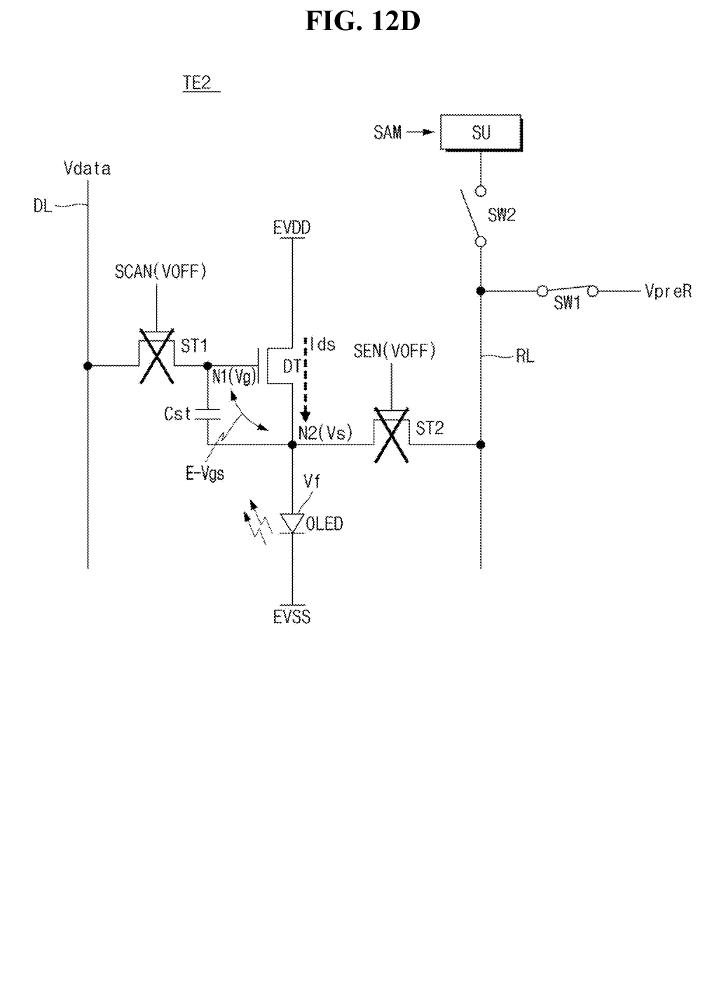

FIG. 11 is a diagram illustrating a gate-source voltage difference of a subpixel based on a VRR driving method according to an example embodiment in a vertical active period ACT and a vertical blank period BLK included in one frame period. FIGS. 12A to 12D are diagrams illustrating an operation of a subpixel in a programming period TA of the vertical active period ACT, an emission period TE1 of the vertical active period ACT, a copy programming period TC of the vertical blank period BLK, and an emission period TE2 of the vertical blank period BLK of FIG. 11, respectively.

As shown in FIG. 11, for a copy programming operation in a vertical blank period BLK, a sense signal SEN may have one or more gate on periods (hereinafter referred to as a VON period) to turn on a second switch transistor ST2 during the vertical blank period BLK.

As shown in FIGS. 11 and 12A, during a programming period TA of a vertical active period ACT, the scan signal SCAN and the sense signal SEN may maintain a VON period. Thus, both of a first switch transistor ST1 and the second switch transistor ST2 may be turned on. A data voltage Vdata may be applied to a first node N1 connected to a gate electrode of a driving transistor DT through the first switch transistor ST1 and may be a gate voltage Vg of the driving transistor DT. An initialization voltage VpreR may be applied to a second node N2 connected to a source electrode of the driving transistor DT through the second switch transistor ST2 and may be a source voltage Vs of the driving transistor DT. As a result, a gate-source voltage difference “W-Vgs” set in the programming period TA of the vertical active period ACT may be “Vdata-VpreR.” The gate-source voltage difference “W-Vgs” may be greater than a threshold voltage of the driving transistor DT.

In a boosting period TB1 of the vertical active period ACT, the first switch transistor ST1 and the second switch transistor ST2 may be turned off by a scan signal SCAN and a sense signal SEN of a gate off voltage VOFF. The gate-source voltage difference “W-Vgs” of the programming period TA may be maintained, and a driving current corresponding to the gate-source voltage difference “W-Vgs” may flow through the driving transistor DT. Based on such driving current, the source voltage Vs of the driving transistor DT may be boosted up to a turn-on voltage Vf of a light emitting element OLED. At this time, the gate voltage Vg of the driving transistor DT may increase based on cap-boosting by a storage capacitor Cst. However, due to a first cap-boosting loss, an increase magnitude of the gate voltage Vg may be less than an increase magnitude of the source voltage Vs.

As shown in FIGS. 11 and 12B, in an emission period TE1 of the vertical active period ACT, a gate-source voltage difference “E-Vgs” of the emission period TE1, which is less than the gate-source voltage difference “W-Vgs” of the programming period TA, may be set due to the cap-boosting loss. The cap-boosting loss may be defined as “capacitance Cst/(capacitance Cst + parasitic capacitance Cx).” The parasitic capacitance Cx may be defined as a total sum of parasitic capacitances affecting the gate electrode of the driving transistor DT. As the parasitic capacitance Cx increases, the cap-boosting loss may increase, and a difference between “W-Vgs” and “E-Vgs” may increase. In the emission period TE1 of the vertical active period ACT, a driving current Ids corresponding to the gate-source voltage difference “E-Vgs” may be applied from the driving transistor DT to the light emitting element OLED. The light emitting element OLED may emit light with the driving current.

As shown in FIGS. 11 and 12C, during a copy programming period TC of the vertical blank period BLK, the sense signal SEN may maintain the VON period. Thus, the second switch transistor ST2 may be turned on. At this time, the first switch transistor ST1 may be turned off by the scan signal SCAN of the gate off voltage VOFF. The initialization voltage VpreR may be applied to the second node N2 connected to the source electrode of the driving transistor DT through the second switch transistor ST2. Thus, the source voltage Vs of the driving transistor DT may be down-boosted to the initialization voltage VpreR from a turn-on voltage Vf of the light emitting element OLED. At this time, the gate voltage Vg of the driving transistor DT may also be reduced due to the cap-boosting by the storage capacitor Cst. However, due to a second cap-boosting loss, a decrease magnitude of the gate voltage Vg may be less than a decrease magnitude of the source voltage Vs.

In the copy programming period TC of the vertical blank period BLK, a gate-source voltage difference “B-Vgs,” which is substantially the same as the gate-source voltage difference “W-Vgs” of the programming period TA, may be set. In each of “W-Vgs” and “B-Vgs,” the gate voltage Vg may be the data voltage Vdata, and the source voltage Vs may be the initialization voltage VpreR.

The programming period TA of the vertical active period ACT and the copy programming period TC of the vertical blank period BLK may have the same length. Therefore, even when only the second switch transistor ST2 is on-driven based on the sense signal SEN of the VON period in the copy programming period TC of the vertical blank period BLK, the same programming effect may be obtained as in the programming period TA of the vertical active period ACT when both of the first and second switch transistors ST1 and ST2 are on-driven. The gate-source voltage difference “W-Vgs,” which is set in the programming period TA of the vertical active period ACT, may be the same as the gate-source voltage difference “B-Vgs” set in the copy programming period TC of the vertical blank period BLK.

In the copy programming period TC of the vertical blank period BLK, the gate voltage Vg may vary through only cap-boosting. Because the second cap-boosting loss acts in a direction opposite to the first cap-boosting loss, the gate voltage Vg of the “B-Vgs” may be recovered to the data voltage Vdata which is set at a latter portion of the programming period TA of the vertical active period ACT.

In a boosting period TB2 of the vertical blank period BLK, the first switch transistor ST1 and the second switch transistor ST2 may be turned off by the scan signal SCAN and the sense signal SEN of the gate off voltage VOFF. The gate-source voltage difference “B-Vgs” of the copy programming period TC may be maintained, and a driving current corresponding to the gate-source voltage difference “B-Vgs” may flow in the driving transistor DT. Based on the driving current, the source voltage Vs of the driving transistor DT may be boosted up to the turn-on voltage Vf of the light emitting element OLED. At this time, the gate voltage Vg of the driving transistor DT may increase based on cap-boosting by the storage capacitor Cst. However, due to the first cap-boosting loss, an increase amount of the gate voltage Vg may be less than an increase amount of the source voltage Vs.

As shown in FIGS. 11 and 12D, in an emission period TE2 of the vertical blank period BLK, a gate-source voltage difference “E-Vgs” of the emission period TE2, which is less than the gate-source voltage difference “B-Vgs” of the copy programming period TC, may be set by a cap-boosting loss. In the emission period TE2 of the vertical blank period BLK, a driving current corresponding to the gate-source voltage difference “E-Vgs” may be applied from the driving transistor DT to the light emitting element OLED. The light emitting element OLED may emit light with the driving current.

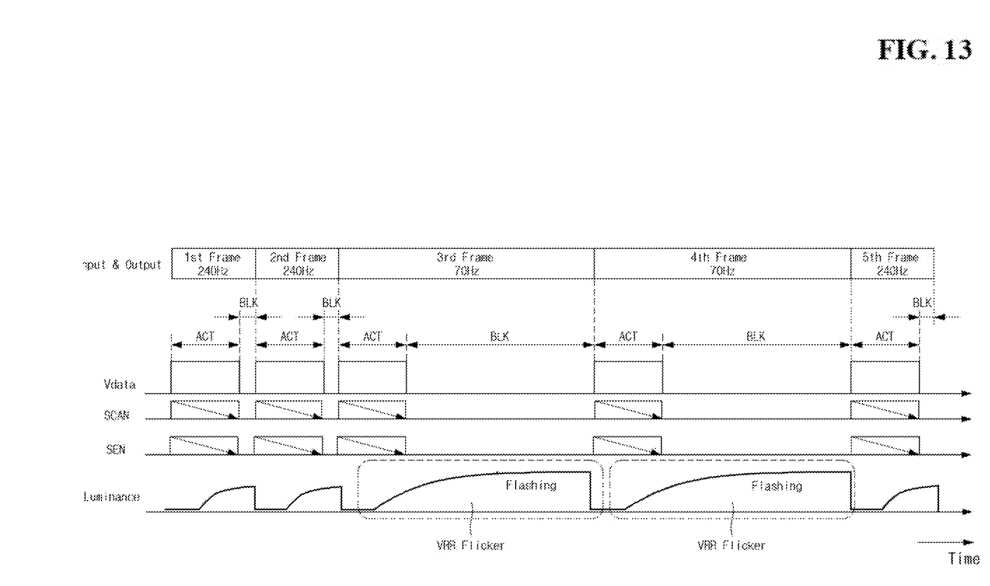

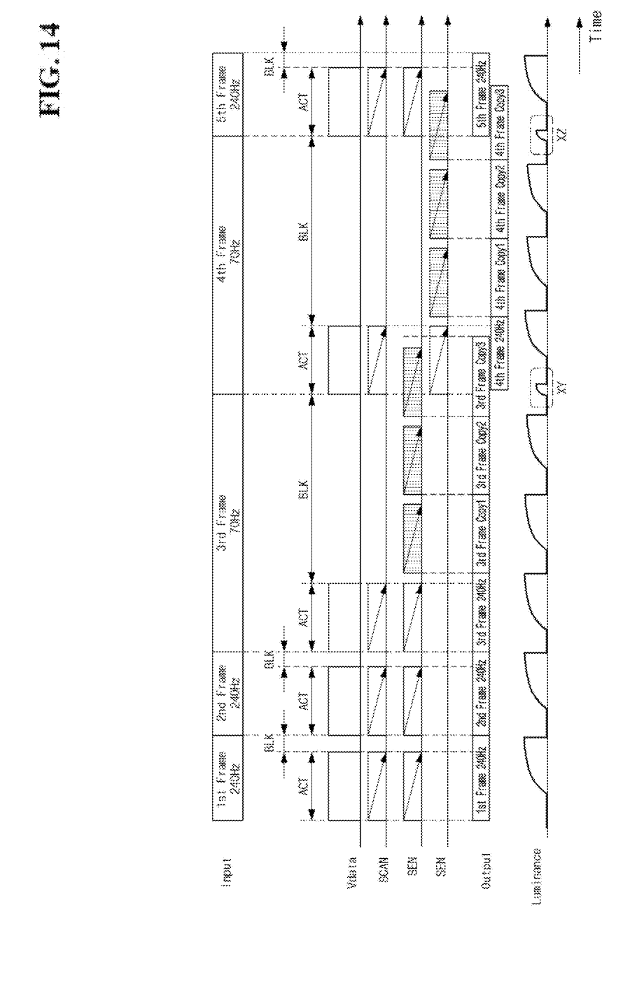

FIG. 13 is a diagram illustrating an example where luminance flashing occurs in a conventional VRR driving method. FIG. 14 is a diagram illustrating an example where luminance flashing is prevented or suppressed in a VRR driving method according to an example embodiment of the present disclosure.

As illustrated in FIG. 13, in the conventional VRR driving method where a programming operation is performed in only a vertical active period, a real-time luminance integral value (i.e., recognition luminance) may increase in third and fourth frames where a frame frequency is relatively low at 70 Hz. Thus, luminance flashing may occur. Accordingly, VRR flicker caused by a change in recognition luminance may occur when the frame frequency is rapidly changed from 240 Hz to 70 Hz.

On the other hand, as shown in FIG. 14, in the VRR driving method according to an example embodiment of the present disclosure, copy programming periods which are a non-emission period may be further disposed in the third and fourth frames where a frame frequency is relatively low at 70 Hz. Thus, luminance flashing in vertical blank period BLK of the third and fourth frames may be prevented or suppressed. According to an example embodiment of the present disclosure, because luminance is hardly changed even when the frame frequency is rapidly changed from 240 Hz to 70 Hz, VRR flicker may not be recognized.

Because a third copy programming period of the third frame overlaps a programming period of the fourth frame, a length of an emission period based on the third copy programming period of the third frame may be reduced. Thus, a luminance level XY may be lower than emission periods of a normal length.

Likewise, because a third copy programming period of the fourth frame overlaps a programming period of a fifth frame, a length of an emission period based on the third copy programming period of the fourth frame may be reduced. Thus, a luminance level XZ may be lower than emission periods of a normal length.

However, in one frame period, a period when the luminance level XY is implemented or a period when the luminance level XZ is implemented may be very short, and the luminance level XY or the luminance level XZ may overlap a luminance level of a subsequent frame and may be recognized at the same time. Thus, there may be little to no recognizable problem.

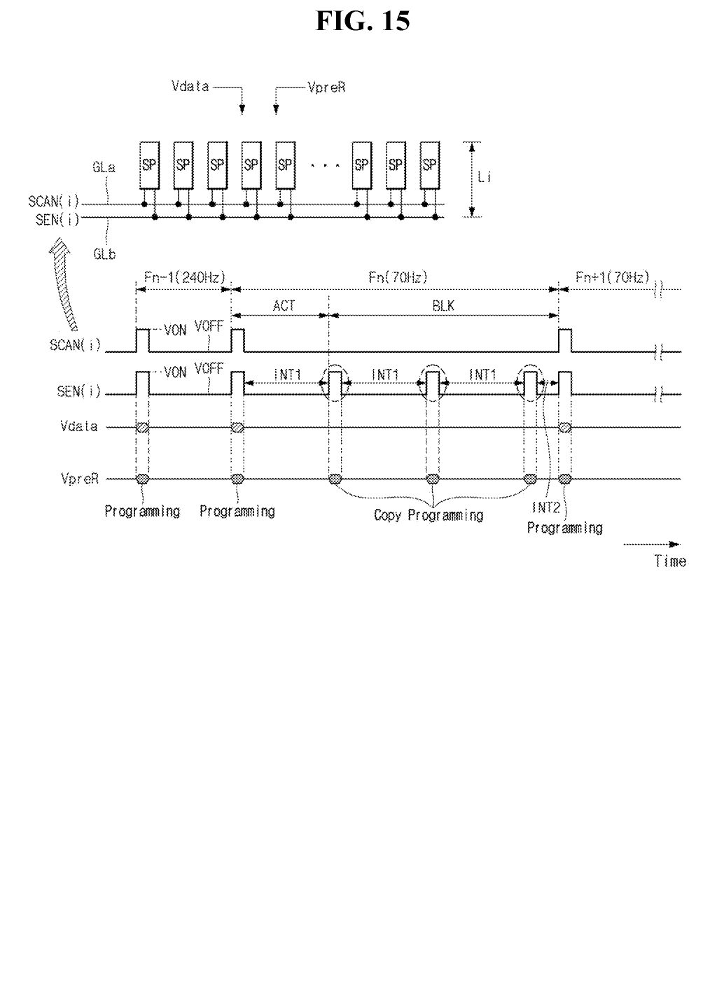

FIG. 15 is a diagram illustrating a feature associated with an interval between a plurality of gate on periods included in a sense signal in a VRR driving method according to an example embodiment of the present disclosure.

As illustrated in FIG. 15, for a copy programming operation for decreasing VRR flicker, a sense signal SEN according to an example embodiment of the present disclosure may have one or more VON periods to turn on a second switch transistor ST2 during a vertical blank period BLK, at a frame frequency of 70 Hz which is lower than a max frame frequency of 240 Hz. Also, for a programming operation at a frame frequency of 70 Hz, a scan signal SCAN according to an example embodiment of the present disclosure may have one VON period to turn on a first switch transistor ST1 during a vertical active period ACK, and the sense signal SEN may have one VON period to turn on the second switch transistor ST2 during the vertical active period ACK.

In other words, in a frame frequency of 70 Hz which is lower than the max frame frequency of 240 Hz, the scan signal SCAN supplied to one subpixel may include one VON period, and the sense signal SEN supplied to the one subpixel may include two or more VON periods.

Here, a first VON period of the sense signal SEN may overlap a VON period of the scan signal SCAN, and a VON period of the sense signal SEN subsequent to the first VON period may overlap a VOFF period of the scan signal SCAN.

As shown in FIG. 15, intervals between a plurality of VON periods included in the sense signal SEN in an n^{th} (where n may be a natural number) frame Fn may have the same first interval INT1. Thus, luminance distortion may be maximally or effectively reduced in one programming operation and in a plurality of copy programming operations.

As illustrated in FIG. 15, an interval between a last VON period of a sense signal SEN disposed in the n^{th} frame Fn and a first VON period of a sense signal SEN disposed in an (n+1)^{th} frame Fn+1 may have a second interval INT2 which is less than the first interval INT1. Despite such a configuration, a programming operation based on a data voltage Vdata and performed in the (n+1)^{th} frame Fn+1 may not cause a problem. This is because a copy programming operation is performed based on only an initialization voltage VpreR without the data voltage Vdata, in the last VON period of the sense signal SEN disposed in the n^{th} frame Fn.

As described above according to an example embodiment of the present disclosure, a programming period of the (n+1)^{th} frame Fn+1 may start before a last copy programming period of the n^{th} frame Fn ends. Thus, in terms of a programming operation, because there is no output delay with respect to an input, it may not be required to include a memory for copying a frame image.

In the above example embodiments of the present disclosure, by using a frequency variable display apparatus where a length of a vertical blank period is changed based on a frame frequency, one or more copy programming operations may be performed during a vertical blank period at a frame frequency lower than a predetermined max frame frequency. Thus, a luminance flashing phenomenon and VRR flicker occurring when a frame frequency is rapidly changed may be reduced.

The effects according to the present disclosure are not limited to the above examples, and other various effects may be included in or can be understood from the present disclosure or may be attained from the practice of various embodiments of the present disclosure.

While the present disclosure has been particularly shown and described with reference to example embodiments, it will be understood by those of ordinary skill in the art that various changes in form and details may be made therein without departing from the spirit and scope of the present disclosure.

Thus, it is intended that the present disclosure cover the modifications and variations of the present disclosure provided they come within the scope of the appended claims and their equivalents.

What is claimed is:

1. A frequency variable display apparatus, comprising:
a display panel including a plurality of subpixels, each including:
a driving transistor including a gate electrode connected to a first node, a drain electrode connected to a high-level source voltage, and a source electrode connected to a second node;
a first switch transistor configured to connect the first node to a data line based on a scan signal, the data line being configured to receive a data voltage;
a second switch transistor configured to connect the second node to a reference voltage line based on a sense signal, the reference voltage line being configured to receive an initialization voltage;
a storage capacitor connected between the first node and the second node; and
a light emitting element including an anode electrode connected to the second node and a cathode electrode connected to a low-level source voltage; and
a gate driver configured to supply the scan signal to a scan gate line connected to a gate electrode of the first switch transistor and to supply the sense signal to a sense gate line connected to a gate electrode of the second switch transistor,
wherein one frame period comprises:
a vertical active period during which the data voltage is input to a corresponding one of the subpixels; and
a vertical blank period which follows the vertical active period and during which the data voltage is not input to the corresponding one of the subpixels, and
wherein, in the one frame period with the display panel driven at a frame frequency lower than a predetermined maximum frame frequency within a variable frame frequency range, the sense signal has one or more gate on periods to turn on the second switch transistor during the vertical blank period.

2. The frequency variable display apparatus of claim 1, wherein:
a length of the vertical active period is fixed based on the predetermined maximum frame frequency; and
a length of the vertical blank period is variable and increases as the frame frequency is lowered below the predetermined maximum frame frequency.

3. The frequency variable display apparatus of claim 2, wherein:
during a programming period of the vertical active period, the scan signal and the sense signal maintain a gate on period, and the first switch transistor and the second switch transistor are turned on; and
during a copy programming period of the vertical blank period, the scan signal maintains a gate off period, the sense signal maintains a gate on period, the first switch transistor is turned off, and the second switch transistor is turned on.

4. The frequency variable display apparatus of claim 3, wherein the programming period and the copy programming period have the same length.

5. The frequency variable display apparatus of claim 4, wherein a gate-source voltage difference of the driving transistor in the programming period is equal to a gate-source voltage difference of the driving transistor in the copy programming period.

6. The frequency variable display apparatus of claim 3, wherein, with the display panel driven at the frame frequency lower than the predetermined maximum frame frequency, the vertical blank period includes one or more of the copy programming period.

7. The frequency variable display apparatus of claim 6, wherein a number of copy programming periods included in the vertical blank period increases as a length of the vertical blank period increases.

8. The frequency variable display apparatus of claim 1, wherein:
intervals between a plurality of gate on periods of the sense signal in an n^{th} (where n is a natural number) frame are each equal to a first interval; and
an interval between a last gate on period of the sense signal in the n^{th} frame and a first gate on period of the sense signal in an (n+1)^{th} frame is equal to a second interval shorter than the first interval.

9. A frequency variable display apparatus, comprising:
a display panel including a plurality of subpixels, each including:
a driving transistor including a gate electrode connected to a first node, a drain electrode connected to a high-level source voltage, and a source electrode connected to a second node;
a first switch transistor configured to connect the first node to a data line based on a scan signal, the data line being configured to receive a data voltage;
a second switch transistor configured to connect the second node to a reference voltage line based on a sense signal, the reference voltage line configured to receive an initialization voltage;
a storage capacitor connected between the first node and the second node; and
a light emitting element including an anode electrode connected to the second node and a cathode electrode connected to a low-level source voltage; and
a gate driver configured to supply the scan signal to a scan gate line connected to a gate electrode of the first switch transistor and to supply the sense signal to a sense gate line connected to a gate electrode of the second switch transistor,
wherein, in one frame period with the display panel driven at a frame frequency lower than a predetermined maximum frame frequency within a variable frame frequency range, the scan signal supplied to one of the subpixels has one gate on period, and the sense signal supplied to the one of the subpixels has two or more gate on periods.

10. The frequency variable display apparatus of claim 9, wherein, during the one frame period with the display panel driven at the frame frequency lower than the predetermined maximum frame frequency:
the one gate on period of the sense signal overlaps one of the two or more gate on periods of the scan signal; and
a subsequent one of the two or more gate on periods of the sense signal overlaps a gate off period of the scan signal.

11. The frequency variable display apparatus of claim 9, wherein:
the one frame period comprises:
a vertical active period during which the data voltage is input to a corresponding one of the subpixels; and
a vertical blank period which follows the vertical active period and during which the data voltage is not input to the corresponding one of the subpixels;
a length of the vertical active period is fixed based on the predetermined maximum frame frequency; and
a length of the vertical blank period is variable and increases as the frame frequency is lowered below the predetermined maximum frame frequency.

12. The frequency variable display apparatus of claim 9, wherein:
intervals between the two or more gate on periods of the sense signal in an n^{th} (where n is a natural number) frame are each equal a first interval; and
an interval between the last of the two or more gate on periods of the sense signal in the n^{th} frame and a first gate on period of the sense signal in an (n+1)^{th} frame is equal to a second interval shorter than the first interval.

13. A display apparatus, comprising:
a display panel configured to be driven at a variable frame frequency within a frequency range, display panel comprising a subpixel including:
a driving transistor having a gate electrode connected to a first node and a first electrode connected to a second node;
a first switch transistor having a gate electrode connected to a scan gate line, a first electrode connected to a data line configured to receive a data voltage, and a second electrode connected to the first node;
a second switch transistor having a gate electrode connected to a sense gate line, a first electrode connected to a reference voltage line configured to receive an initialization voltage, and second electrode connected to the second node; and
a light emitting element connected to the second node;
a data driver configured to provide the data voltage to the data line; and
a gate driver configured to provide a scan signal to the scan gate line and to provide a sense signal to the sense gate line,
wherein, during an n^{th} frame (n being a natural number) with the display panel driven at a frame frequency lower than a predetermined maximum frame frequency within the frequency range, the scan signal has one gate on period, and the sense signal has two or more gate on periods.

14. The display apparatus of claim 13, wherein the n^{th} frame comprises:
a vertical active period during which the data voltage is input to the subpixel; and
a vertical blank period which follows the vertical active period and during which the data voltage is not input to the subpixel.

15. The display apparatus of claim 14, wherein:
a length of the vertical active period is fixed based on the predetermined maximum frame frequency; and
a length of the vertical blank period is variable and increases as the frame frequency is lowered below the predetermined maximum frame frequency.

16. The display apparatus of claim 14, wherein:
the vertical active period includes a programming period during which the first switch transistor and the second switch transistor are configured to be turned on; and
the vertical blank period includes one or more copy programming periods during which the first switch transistor is configured to be turned off, and the second switch transistor is configured to be turned on.

17. The display apparatus of claim 16, wherein the programming period and the one or more copy programming periods each have the same length.

18. The display apparatus of claim 17, wherein a number of copy programming periods included in the vertical blank period increases as a length of the vertical blank period increases and the frame frequency is lowered.

19. The display apparatus of claim 13, wherein, during the n^{th} frame:
the one gate on period of the sense signal overlaps one of the two or more gate on periods of the scan signal; and
a subsequent one of the two or more gate on periods of the sense signal overlaps a gate off period of the scan signal.

20. The display apparatus of claim 13, wherein:
intervals between the two or more gate on periods of the sense signal in the n^{th} frame are each equal a first interval; and
an interval between the last of the two or more gate on periods of the sense signal in the n^{th} frame and a first gate on period of the sense signal in an (n+1)^{th} frame is equal to a second interval shorter than the first interval.
